(19) United States
(12) Patent Application Publication
(10) Pub. No.: US 2026/0005389 A1
(43) Pub. Date: Jan. 1, 2026

(54) BATTERY MODULE FOR PREVENTING THERMAL RUNAWAY SPREADING

(71) Applicant: C-TECH.UNITED CORPORATION, New Taipei City (TW)

(72) Inventors: Chih-Kun YANG, New Taipei City (TW); Zheng-Yan YOU, New Taipei City (TW)

(73) Assignee: C-TECH.UNITED CORPORATION, New Taipei City (TW)

(21) Appl. No.: 18/965,754

(22) Filed: Dec. 2, 2024

(30) Foreign Application Priority Data
Jun. 28, 2024 (TW) 113124341

(51) Int. Cl. H01M 50/383; A62C 2/04; A62C 3/16; H01M 10/653; H01M 50/213; H01M 50/271; H01M 50/293; H01M 50/342

(52) U.S. Cl. CPC H01M 50/383; A62C 2/04; A62C 3/16; H01M 10/653; H01M 50/213; H01M 50/271; H01M 50/293; H01M 50/3425

(57) ABSTRACT

Disclosed is a battery module for preventing thermal runaway spreading, comprising: a cell holder; a battery pack, including a plurality of cells; a metal plate, disposed with the cell holder to collaboratively form multiple compartments, with adjacent compartments separated by the extruding separators; a fire-retardant expandable member, disposed within the compartment; and an upper cover, disposed on the cell holder with a intermediate space between the upper cover and the cell holder. The cell holder includes pressure relief openings for the compartments, allowing high-temperature substances released by cells undergoing thermal runaway to pass through the compartments, the pressure relief openings, the intermediate space, and the vent openings in the metal plate to the outside. This allows the pressure to be relieved first, followed by preventing oxygen from fueling the fire, thereby avoiding flames and sparks spreading out of the chassis, and ensuring the safety of surrounding personnel and devices.

### FIELD OF THE INVENTION

The present invention relates to a battery module, and more particularly relates to a battery module for preventing thermal runaway spreading.

### BACKGROUND OF THE INVENTION

The demand for high energy density energy storage systems is on the rise, such as energy storage for electrical grids, backup power for data centers and electric vehicles. The battery modules of these energy storage systems have various safety requirements based on the environment in which they are used. When thermal runaway occurs in the cells of the battery modules, high-temperature flammable gases and flames are generated. One of the safety requirements for the battery modules is to effectively prevent flames and sparks from spreading out of the chassis that accommodates the battery module during thermal runaway. The above thus ensures the overall safety of surrounding devices and personnel.

### SUMMARY OF THE INVENTION

Accordingly, one objective of the present invention is to provide a battery module for preventing thermal runaway spreading, which prevents flames and sparks from spreading out of the chassis that accommodates the battery module when thermal runaway occurs.

In order to overcome the technical problems in prior art, the present invention provides a battery module for preventing thermal runaway spreading, comprising: a cell holder, having a plurality of cell accommodating cavity sets, each of the cell accommodating cavity set having a plurality of cell accommodating cavities, a side of the cell holder having a plurality of extruding separators; a plurality of battery packs, each of the battery pack having a plurality of cells, each of the battery pack corresponding to one cell accommodating cavity set, such that the plurality of cells being horizontally disposed in cell accommodating cavities of the cell accommodating cavity set; a metal plate, disposed at a vertical-surface end of the cell holder, and arranged together with the neighboring extruding separators of the cell holder to collaboratively form a plurality of compartments, wherein the adjacent compartments are separated by the extruding separators, and each of the cell accommodating cavities faces the compartments; a fire-retardant expandable member, disposed within the compartment and adhered to the metal plate, positive terminals of the plurality of cells pointing toward the fire-retardant expandable member; and an upper cover, horizontally disposed on the cell holder with an intermediate space between the upper cover and the cell holder, the metal plate having a vent opening connecting the intermediate space with an outside space, wherein the cell holder has pressure relief openings formed at the vertical end positions of each compartment, the pressure relief openings are connected with the intermediate space, allowing high-temperature substances released by the cells undergoing thermal runaway to pass through the compartments, the pressure relief openings, the intermediate space, and the vent opening to the outside space.

In one embodiment of the present invention, the battery module is provided, wherein an outer surface of the cell holder is in communication with the intermediate space between the upper cover and the cell holder.

In one embodiment of the present invention, the battery module is provided, wherein the cell holder is made of thermally conductive plastic.

In one embodiment of the present invention, the battery module is provided, further comprising a flame-retardant sheet covering the battery pack and the metal plate.

In one embodiment of the present invention, the battery module is provided, wherein the metal plate is two in number, one covering the front side and the other covering the rear side.

In one embodiment of the present invention, the battery module is provided, wherein each end of the cells is arranged corresponding to one of the metal plates and one of the compartments.

With the technical means adopted by the battery module of the present invention, since thermal runaway of the cell often ejects various substances from the positive terminal, the present invention provides the positive terminal of the cell which points toward the fire-retardant expandable member. Since the fire-retardant expandable member is disposed at the metal plate with a space between the fire-retardant expandable member and the cell, when the cell erupts, the pressure can first be relieved, allowing the release of flame energy. Approximately five seconds later, the fire-retardant expandable member reacts and expands to cover the opening of the cell accommodating cavity, thereby preventing oxygen from fueling the fire. The high-temperature substances released by the cell will follow a long pathway as they pass through the compartment, the pressure relief openings, the intermediate space, the vent opening then to the outside space. Such multi-faceted means prevents flames and sparks from spreading out of the chassis, thereby protecting the safety of surrounding personnel and devices.

### BRIEF DESCRIPTION OF THE DRAWINGS

FIG. 1 is a schematic perspective drawing illustrating a battery module according to an embodiment of the present invention;

FIG. 2 is a schematic exploded drawing illustrating the battery module according to the embodiment of the present invention;

FIG. 3 is a schematic cross-sectional side view illustrating the battery module according to the embodiment of the present invention;

FIG. 4 is a schematic cross-sectional top view illustrating a separating plate of the Li-ion battery module along the section line A-A in FIG. 3 according to an embodiment of the present invention; and

FIG. 5 is a partial schematic cross-sectional view illustrating the battery module according to the embodiment of the present invention.

### DETAILED DESCRIPTION OF THE PREFERRED EMBODIMENTS

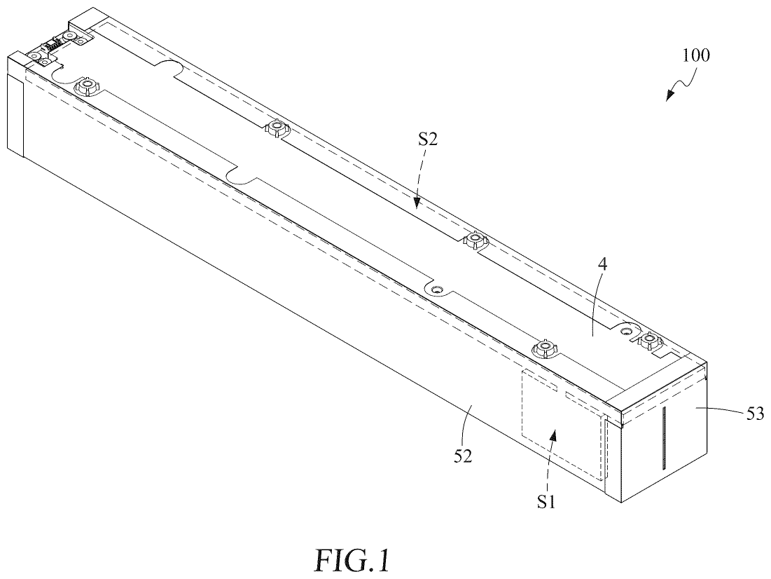

The preferred embodiments of the present invention are described in detail below with reference to FIG. 1 to FIG. 5. The description is used for explaining the embodiments of the present invention only, but not for limiting the scope of the claims.

According to one embodiment of the thermal runaway propagation preventing battery module 100 of the present invention, it is suitable for use in a battery backup unit (BBU) and is installed within a chassis. As shown in FIGS. 1 to 3, the thermal runaway propagation preventing battery module 100 includes: a cell holder 12, a plurality of battery packs 1, a metal plate 2, a fire-retardant expandable member 3, an upper cover 4, a flame-retardant sheet 5, and a battery management system (BMS) 6.

The cell holder 12 having a plurality of cell accommodating cavity sets 122. Each of the cell accommodating cavity set 122 has a plurality of cell accommodating cavities 1221. A side of the cell holder 12 has a plurality of extruding separators 123. Each of the battery pack 1 comprises a plurality of cells 11 and a metal conductive sheet 13. Each of the battery pack 1 corresponds to one cell accommodating cavity set 122. The cells 11 are disposed in the cell accommodating cavities 1221 of the cell holder 12 and connected in parallel and/or series via the metal conductive sheets 13. The cells 11 are Li-ion batteries. The metal conductive sheets 13 are nickel sheets. The battery management system 6 manages the charging and discharging of the cells 11. The cell holder 12 has a plurality of cell accommodating cavity sets. Each of the cell accommodating cavity set has a plurality of cell accommodating cavities. One side of the cell holder 12 has a plurality of extruding separators. In this embodiment, the material of the cell holder 12 is highly thermally conductive plastic such as Nytex, which can rapidly dissipate the heat generated during thermal runaway and is flame-retardant. The temperature of the cell holder 12 can be quickly lowered by having the cell holder 12 contact the metal plate 2, thereby reducing the impact of thermal runaway energy on adjacent cells 11 and effectively delaying the time before the thermal runaway of the adjacent cells 11. An outer surface of the cell holder 12 is in communication with the intermediate space S1 between the upper cover 4 and the cell holder 12.

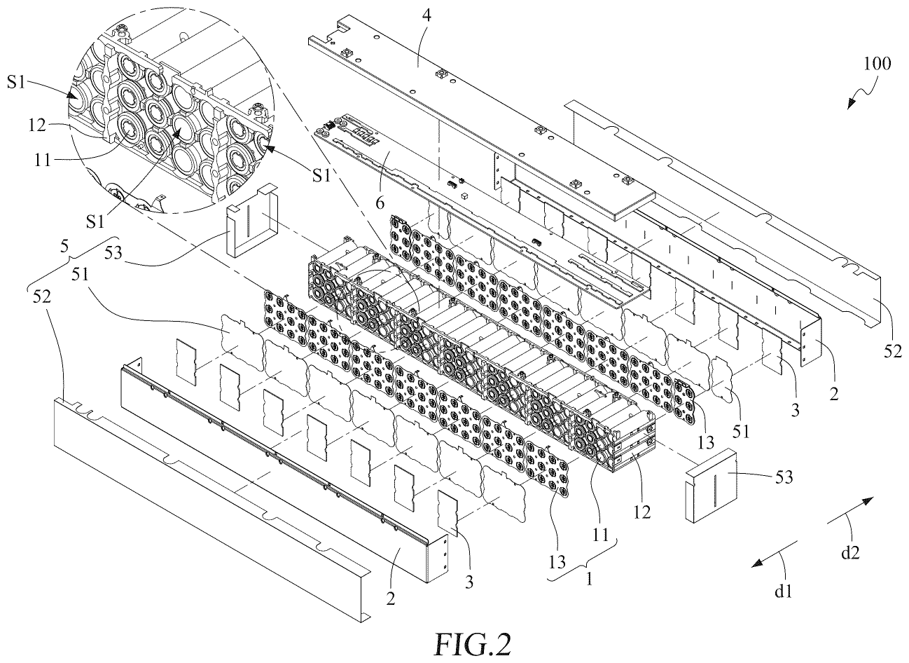

As shown in FIG. 2, in this embodiment, the cells 11 are disposed horizontally. Positive terminals of some of the cells 11 are provided to face a first direction d1 and point toward the fire-retardant expandable member 3 on one side, while positive terminals of the other cells 11 are provided to face a second direction d2 and point toward the fire-retardant expandable member 3 on the opposite side. The first direction d1 and the second direction d2 are opposite to each other.

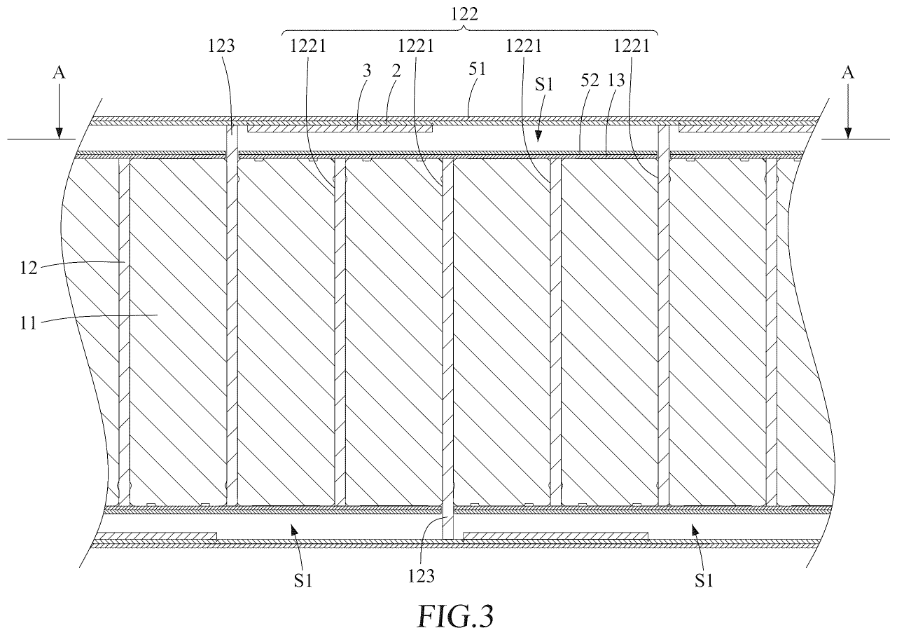

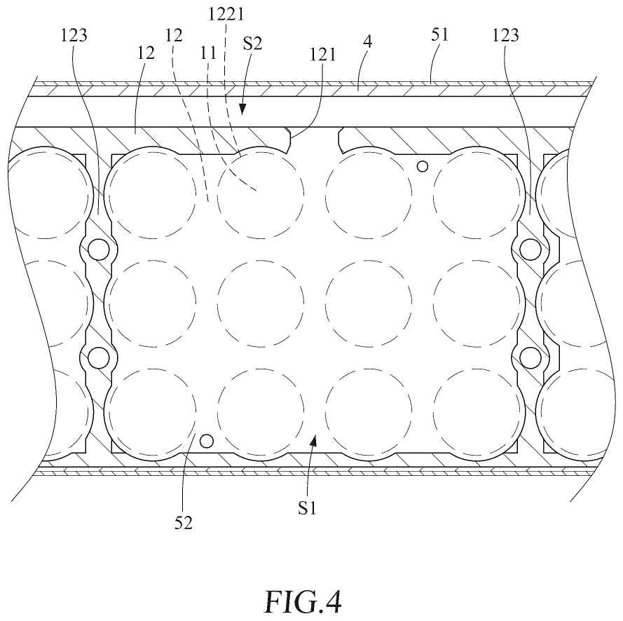

As shown in FIGS. 3 and 4, each end of the cells 11 corresponds to one metal plate 2. The metal plates 2 are disposed at vertical-surface ends of the cell holder 12, and each metal plate 2 is arranged together with the adjacent extruding separators 121 of the cell holder 12 to collaboratively form a plurality of compartments S1. Adjacent compartments S1 are separated by the extruding separators 123, ensuring that high-temperature substances released by the cells 11 only contact a portion of the cells 11 directly. The metal plate 2 is metallic to maintain its shape at high temperatures. The openings of each of the cell accommodating cavity face the compartments S1. Each end of the cells 11 corresponds to one compartment S1.

The fire-retardant expandable member 3 is adhered to the metal plate 2 and disposed within the compartment S1. The reaction temperature of the fire-retardant expandable member 3 is higher than the operating temperature of the cells 11 but lower than a temperature of the products of the thermal runaway of the cells 11. As a result, when the high-temperature substances released by the thermal runaway cell 11 contact the fire-retardant expandable member 3, the fire-retardant expandable member 3 expands in volume and cover the opening of the cell accommodating cavity 1221. Since the fire-retardant expandable member 3 is disposed at the metal plate 2 and is spaced from the cells 11, when a cell 11 erupts, the pressure can first be relieved, allowing the release of flame energy. Approximately five seconds later, the fire-retardant expandable member 3 reacts and expands to cover the opening of the cell accommodating cavity 1221, thereby preventing oxygen from fueling the fire.

The upper cover 4 is horizontally disposed on the cell holder 12 with an intermediate space S2 between the upper cover 4 and the cell holder 12. The battery management system 6 is disposed within the intermediate space S2. The cell holder 12 forms pressure relief openings 121 at the vertical ends of each compartment S1. The pressure relief openings 121 communicate with the intermediate space S2. When a cell 11 erupts, the high-temperature substances released pass through the compartments S1, the pressure relief openings 121 to the intermediate space S2.

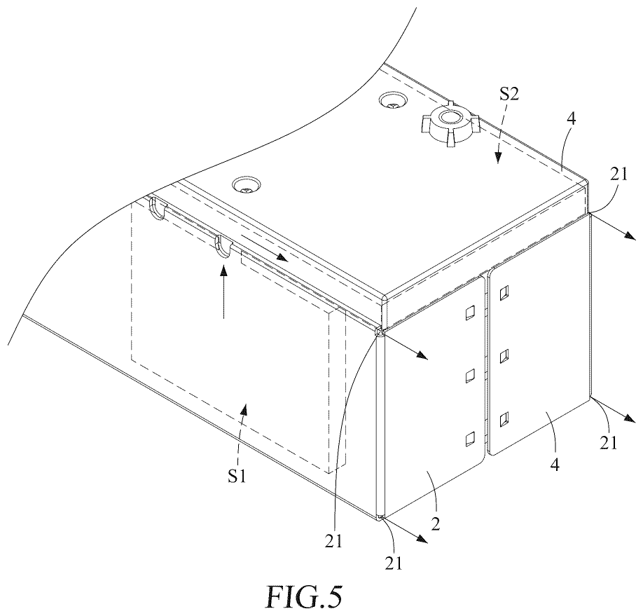

As shown in FIGS. 1 and 5, the intermediate space S2 is one in number. All compartments S1 communicate with the same intermediate space S2. Through the cell holder 12, the intermediate space S2 separated from the plurality of cells 11. In this embodiment, the intermediate space S2 is provided above the battery pack 1

As shown in FIG. 5, in the battery module 100 according to the embodiment of the present invention, the metal plate 2 has a vent opening 21. The vent opening 21 connects the intermediate space S2 to the outside space, allowing the high-temperature substances released by thermal runaway in the cells 11 to pass through the compartments S1, the pressure relief openings 121, the intermediate space S2, the vent openings 21 then to the outside space. The arrows in the figure indicate the pressure relief direction.

As shown in FIGS. 1 and 2, in the battery module 100 according to an embodiment of the present invention, a flame-retardant sheet 5 covers the battery pack 1 and the metal plate 2. The flame-retardant sheet 5 can be YT516 aramid paper or Mylar film, having insulating and flame-retardant properties. Specifically, the flame-retardant sheet 5 includes an inner flame-retardant sheet 51, a side flame-retardant sheet 52, and an end flame-retardant sheet 53. The inner flame-retardant sheet 51 covers the metal conductive sheets 13 of the battery pack 1. The side flame-retardant sheet 52 and end flame-retardant sheet 53 cover the metal plate 2 and the upper cover 4.

In summary, when a cell 11 erupts, the pressure can first be relieved, allowing the release of flame energy. Approximately five seconds later, the fire-retardant expandable member 3 reacts and expands to cover the opening of the cell accommodating cavity, thereby preventing oxygen from fueling the fire. The high-temperature substances released by the cell will follow a long pathway as they pass through the compartment S1, the pressure relief opening 121, the intermediate space S2, the vent opening 21 then to the outside space. Thus, the thermal runaway propagation preventing battery module of present invention prevents flames and sparks from spreading out of the chassis through multi-faceted means, thereby protecting the safety of surrounding personnel and devices.

The above description should be considered as only the discussion of the preferred embodiments of the present invention. However, a person having ordinary skill in the art may make various modifications without deviating from the present invention. Those modifications still fall within the scope of the present invention.

What is claimed is:

1. A battery module for preventing thermal runaway spreading, comprising:
a cell holder, having a plurality of cell accommodating cavity sets, each of the cell accommodating cavity set having a plurality of cell accommodating cavities, a side of the cell holder having a plurality of extruding separators;
a plurality of battery packs, each of the battery pack having a plurality of cells, each of the battery pack corresponding to each of the cell accommodating cavity set, such that the plurality of cells being horizontally disposed in cell accommodating cavities of the cell accommodating cavity set;
a metal plate, disposed at a vertical-surface end of the cell holder, and arranged together with the neighboring extruding separators of the cell holder to collaboratively form a plurality of compartments, wherein the adjacent compartments are separated by the extruding separators, and each of the cell accommodating cavities faces the compartments;
a fire-retardant expandable member, disposed within the compartment and adhered to the metal plate, positive terminals of the plurality of cells pointing toward the fire-retardant expandable member; and
an upper cover, horizontally disposed on the cell holder with a intermediate space between the upper cover and the cell holder, the metal plate having a vent opening connecting the intermediate space with an outside space,
wherein the cell holder has pressure relief openings formed at the vertical end positions of each compartment, the pressure relief openings are connected with the intermediate space, allowing high-temperature substances released by the cells undergoing thermal runaway to pass through the compartments, the pressure relief openings, the intermediate space, and the vent opening to the outside space.

2. The battery module as claimed in claim 1, wherein an outer surface of the cell holder is in communication with the intermediate space between the upper cover and the cell holder.

3. The battery module as claimed in claim 1, wherein the cell holder is made of thermally conductive plastic.

4. The battery module as claimed in claim 1, further comprising a flame-retardant sheet covering the battery pack and the metal plate.

5. The battery module as claimed in claim 1, wherein the metal plate is two in number, one covering the front side and the other covering the rear side.

6. The battery module as claimed in claim 1, wherein each end of the cells is arranged corresponding to one of the metal plates and one of the compartments.
